(19) United States
(12) Patent Application Publication
(10) Pub. No.: US 2026/0261049 A1
(43) Pub. Date: Sep. 3, 2026

(54) TUNABLE MECHANICALLY RECONFIGURABLE FREQUENCY SELECTIVE SURFACE BASED ON ROTATING RIGID STRUCTURES

(71) Applicant: Dalian University of Technology, Dalian City (CN)

(72) Inventors: Ning LIU, Dalian City (CN); Xianjun SHENG, Dalian City (CN); Yankai HONG, Dalian City (CN)

(73) Assignee: Dalian University of Technology, Dalian City (CN)

(21) Appl. No.: 19/550,071

(22) Filed: Feb. 25, 2026

(30) Foreign Application Priority Data
Feb. 28, 2025 (CN) 202510234648.3

(51) Int. Cl. H01Q 15/00

(52) U.S. Cl. CPC H01Q 15/002

(57) ABSTRACT

Provided is a tunable mechanically reconfigurable frequency selective surface based on rotating rigid structures, including N frequency selective surface units which are arranged in an arrangement of a periodic shape array. The frequency selective surface unit includes four frequency selective surface subunits, the frequency selective surface subunit includes a dielectric substrate and an annular conductive layer; the annular conductive layer is arranged on a surface of the dielectric substrate, and the four frequency selective surface subunits are connected in such a way that angles between adjacent frequency selective surface subunits are α degrees, 180-α degrees, α degrees and 180-α degrees.

### CROSS-REFERENCE TO RELATED APPLICATION

This patent application claims the benefit and priority of Chinese Patent Application No. 202510234648.3 filed with the China National Intellectual Property Administration on Feb. 28, 2025, the disclosure of which is incorporated by reference herein in its entirety as part of the present application.

### TECHNICAL FIELD

The present disclosure belongs to the technical field of electromagnetic metamaterials, and relates to a tunable mechanically reconfigurable frequency selective surface based on rotating rigid structures.

### BACKGROUND

A Frequency Selective Surface (FSS) is a two-dimensional structure with a periodic structure, which can selectively reflect, transmit or absorb electromagnetic waves in a specific frequency range. The FSS is widely used in the fields such as wireless communication, electromagnetic shielding, and radar stealth. In the context of rapid evolution of modern communication technologies, the demand for a FSS with higher flexibility and adaptability has become increasingly prominent.

A passive FSS is generally designed as a static structure, which cannot be regulated according to changes in the operating environments or demands. Once the design is completed, the electromagnetic characteristics of the passive FSS are unchangeable, which limits its adaptability in complex electromagnetic environments. To overcome the deficiencies of the passive FSS, the Reconfigurable Frequency Selective Surface (RFSS) has begun to attract widespread attention among scholars. In Documents^{[1-3]}, tuning of the resonant frequency of the FSS is achieved by introducing active components. In Documents^{[4-6]}, dielectric materials with variable electromagnetic characteristics are employed, and the tuning of the resonant frequency of the FSS is achieved by changing the electromagnetic characteristics of the dielectric materials. In Documents^{[7-10]}, the tuning of the resonant frequency of the FSS is achieved by changing the structures or the array arrangement mode of the FSS units via mechanical deformation. The foregoing RFSS can achieve real-time regulation of the electromagnetic characteristics as required, thereby adapting to complex external electromagnetic environments better.

Among the numerous design concepts of RFSS, a mechanical tuning method based on changing a shape of a flexible substrate of the RFSS has gradually attracted increasing attention due to its advantages of low loss, simple structure, no need for a bias network, and excellent tuning continuity.

A number of Mechanically Reconfigurable Frequency Selective Surfaces (MRFSS) based on changing the shape of the flexible substrate of the RFSS have been proposed. In Documents^{[11-14]}, a RFSS based on an Origami substrate is designed, and tuning is achieved by changing a folding angle of the substrate of RFSS unit. In Documents^{[15], [16]}, FSS unit is loaded on a flexible substrate, and tuning is achieved by stretching the flexible substrate. With the development of materials science, mechanical metamaterials are applied to the design of electromagnetic metamaterials in Documents^{[17], [18]}, Although the foregoing MRFSS can achieve the tuning of the resonant frequency, there are still defects such as limited tuning range, poor polarization stability, and incapability of achieving continuous tuning.

### SUMMARY

To solve the foregoing problems, a technical solution adopted by the present disclosure is as follows. A tunable mechanically reconfigurable frequency selective surface based on rotating rigid structures includes N frequency selective surface units, where the N frequency selective surface units are in an arrangement of a periodic shape array;
each of the N frequency selective surface units includes four frequency selective surface subunits;
each of the four frequency selective surface subunits includes a dielectric substrate and an annular conductive layer;
the annular conductive layer is arranged on a surface of the dielectric substrate; and
the four frequency selective surface subunits are connected in such a way that angles between adjacent frequency selective surface subunits are α degrees, 180-α degrees, α degrees and 180-α degrees.

Furthermore, the arrangement of the periodic shape array includes a matrix arrangement.

Furthermore, the dielectric substrate is in a rotating rigid structure.

Furthermore, the dielectric substrate is square.

Furthermore, a center of the annular conductive layer coincides with a center of the dielectric substrate.

Furthermore, 0°≤α≤90°.

Furthermore, a distance d1 from an outer edge of the annular conductive layer to an edge of the dielectric substrate is greater than 0.

Furthermore, a distance d2 between centers of annular conductive layers of adjacent frequency selective surface subunits is greater than 0.

Furthermore, the adjacent frequency selective surface subunits are connected by a hinge structure.

Furthermore, the annular conductive layer is made of a high-conductivity material.

According to a tunable mechanically reconfigurable frequency selective surface based on rotating rigid structures provided by the present disclosure, the tuning of a resonant frequency of the frequency selective surface is achieved by changing an included angle of the adjacent dielectric substrates in the rotating rid structure. As the rotating rigid structure serves as the dielectric substrate, mechanical deformation merely occurs on a horizontal plane during tuning, reducing the complexity of the mechanical tuning. The present disclosure has the advantages of large frequency tuning range, strong polarization stability, and excellent tuning continuity, and has great application potential in the fields of wearable devices and radomes. The present disclosure has the following advantages.

(1) According to the present disclosure, the purpose of tuning is achieved by changing rotation angles of units in the rotating rigid structure and then changing an electromagnetic coupling relationship between conductive rings. A periodic shape of units of the MRFSS structure can be changed by applying a simple external force on the rotating rigid structures, thereby reducing the difficulty of mechanical tuning.

(2) According to the present disclosure, the rotating rigid structure serves as a dielectric substrate of MRFSS to achieve frequency tuning of the MRFSS. The rotating rigid structure has rich topological structure and arrangement, which makes the design of the FSS more flexible.

(3) The present disclosure exhibits a band-stop frequency response, and a resonant point of a stopband can achieve continuous frequency tuning over a wide range; and an experimental result has better consistency with a simulation result.

(4) The present disclosure has strong polarization stability due to structural symmetry.

(5) The present disclosure is simple in structure, easy to process, and has low requirement to processing accuracy.

(6) The present disclosure can be fabricated via a 3D (Three-dimensional) printing technology, which greatly simplifies fabrication steps, shortens the fabrication time, and reduces the consumption of materials.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1A is a 3D diagram of the structure of the frequency selective surface subunit;

FIG. 1B is a top view of the structure of the frequency selective surface subunit;

FIG. 1C is a side view of the structure of the frequency selective surface subunit;

FIG. 1D is a bottom view of the structure of the frequency selective surface subunit;

FIG. 2A is a top view of the frequency selective surface subunits with a 90° included angle α between adjacent squares;

FIG. 2B is a top view of the frequency selective surface subunits with a 45° included angle α between adjacent squares;

FIG. 2C is a top view of the frequency selective surface subunits with a 0° included angle α between adjacent squares;

FIG. 3 shows simulated transmission coefficients of MRFSSs with different included angles between adjacent squares;

FIG. 4A is a diagram of the overall structure of the MRFSS sample with a 90° included angle α between adjacent squares;

FIG. 4B is a diagram of the overall structure of the MRFSS sample with a 60° included angle α between adjacent squares;

FIG. 4C is a diagram of the overall structure of the MRFSS sample with a 30° included angle α between adjacent squares

FIG. 4D is a diagram of the overall structure of the MRFSS sample with a 0° included angle α between adjacent squares;

FIG. 5 is a diagram of an experimental apparatus;

FIG. 6A shows measured transmission coefficients of the MRFSS sample with different included angles between adjacent squares; and

FIG. 6B is a comparison diagram of measured resonant frequencies and simulated resonant frequencies.

### REFERENCE NUMERALS

1—dielectric substrate, 2—annular conductive layer.

### DETAILED DESCRIPTION OF THE EMBODIMENTS

It should be noted that embodiments in the present disclosure and features in the embodiments can be mutually combined in the case of no conflict. The present disclosure is described in detail below with reference to accompanying drawings and embodiments.

To make the objectives, technical solutions and advantages of the embodiments of the present disclosure clearer, the technical solutions in the embodiments of the present disclosure are illustrated clearly and completely below in conjunction with accompanying drawings in the embodiments of the present disclosure. Apparently, the embodiments described are a part rather than all embodiments of the present disclosure. The following description of at least one example embodiment is merely illustrative in nature and is not intended to be any limitation on the present disclosure and its application or use. Based on the embodiments in the present disclosure, all other embodiments obtained by those of ordinary skill in the art without creative effects shall fall within the scope of protection of the present disclosure.

A tunable mechanically reconfigurable frequency selective surface based on rotating rigid structures includes N frequency selective surface units. The N frequency selective surface units are arranged in a periodic shape array, and N≥0.

The frequency selective surface unit includes four frequency selective surface subunits.

The frequency selective surface subunit includes a dielectric substrate 1 and an annular conductive layer 2.

The annular conductive layer 2 is arranged on a surface of the dielectric substrate 1.

The four frequency selective surface subunits are connected in such a way that angles between adjacent frequency selective surface subunits are α degrees, 180-α degrees, α degrees, and 180-α degrees. The tuning of resonant frequency is achieved by changing included angles between squares of adjacent dielectric substrates 1 in a rotating rigid structure and then changing an electromagnetic coupling relationship between conductive rings.

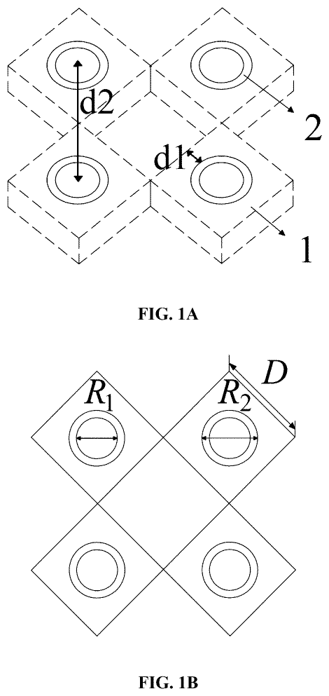

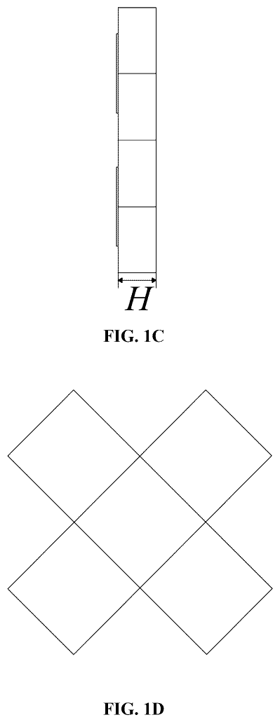

FIG. 1A is a 3D diagram of the structure of the frequency selective surface subunit, FIG. 1B is a top view of the structure of the frequency selective surface subunit, FIG. 1C is a side view of the structure of the frequency selective surface subunit, and FIG. 1D is a bottom view of the structure of the frequency selective surface subunit.

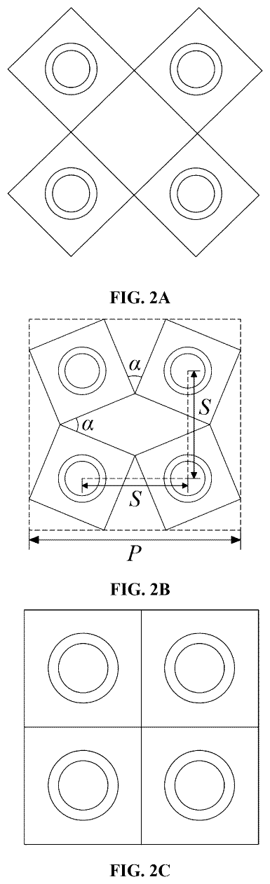

FIG. 2A is a top view of the frequency selective surface subunits with a 90° included angle α between adjacent squares, FIG. 2B is a top view of the frequency selective surface subunits with a 45° included angle α between adjacent squares, and FIG. 2C is a top view of the frequency selective surface subunits with a 0° included angle α between adjacent squares.

Furthermore, the arrangement of the periodic shape array includes a matrix arrangement.

Furthermore, the dielectric substrate 1 is in a rotating rigid structure.

Furthermore, the dielectric substrate 1 is square, rectangular, triangular, hexagonal, and the like.

Furthermore, the center of the annular conductive ring 2 coincides with the center of the dielectric substrate 1.

Furthermore, 0°≤α≤90°.

Furthermore, a distance d1 from an outer edge of the annular conductive layer 2 to an edge of the dielectric substrate 2 is greater than 0.

Furthermore, a distance d2 between centers of the annular conductive layers 2 of adjacent frequency selective surface subunits is greater than 0.

Furthermore, a thickness d of the dielectric substrate 1 ranges such that 6 mm≥d≥0.

Furthermore, the adjacent frequency selective surface subunits are connected by a hinge structure.

Furthermore, the annular conductive layer is made of a high-conductivity material. The high-conductivity material is a high-conductive material such as copper, silver, and graphite.

Embodiment 1: A tunable mechanically reconfigurable frequency selective surface based on rotating rigid structures includes N frequency selective surface units. The N frequency selective surface units are arranged in a periodic shape array.

The frequency selective surface unit includes four frequency selective surface subunits.

The frequency selective surface subunit includes a dielectric substrate 1 and an annular conductive layer 2. The dielectric substrate 1 is in a shape of square, and a side length D of the square of the dielectric substrate 1 is 10 mm.

A thickness H of the square of the dielectric substrate 1 in the rotating rigid structure is 4 mm.

The annular conductive layer 2 is arranged on the surface of the dielectric substrate 1.

The annular conductive layer 2 has a thickness t of 0.008 mm.

The annular conductive layer 2 has an outer diameter R2 of 6 mm;

The annular conductive layer 2 has an inner diameter R1 of 4.4 mm.

The four frequency selective surface subunits are connected in such a way that angles between adjacent frequency selective surface subunits are α degrees, 180-α degrees, α degrees, and 180-α degrees. The tuning of resonant frequency is achieved by changing included angles between squares of the adjacent dielectric substrates 1 in the rotating rigid structure and then changing an electromagnetic coupling relationship between conductive rings.

The top views of the proposed MRFSS units with different included angles between squares of the adjacent dielectric substrates 1 are shown in FIGS. 2A-2C, and a distance between the centers of adjacent annular conductive layers is S, which is calculated according to the following formula:

$$S = D [ cos ( \frac{α}{2} ) + sin ( \frac{α}{2} ) ]$$

where D is a side length of a square of the dielectric substrate 1, and α is an outer included angle between adjacent dielectric substrates 1.

It can be seen from the above formula that the distance S between the centers of the adjacent annular conductive layers can be changed by changing the included angle α between the adjacent dielectric substrates 1, thereby changing an electromagnetic coupling relationship between the conductive rings and achieving the purpose of tuning of resonant frequency.

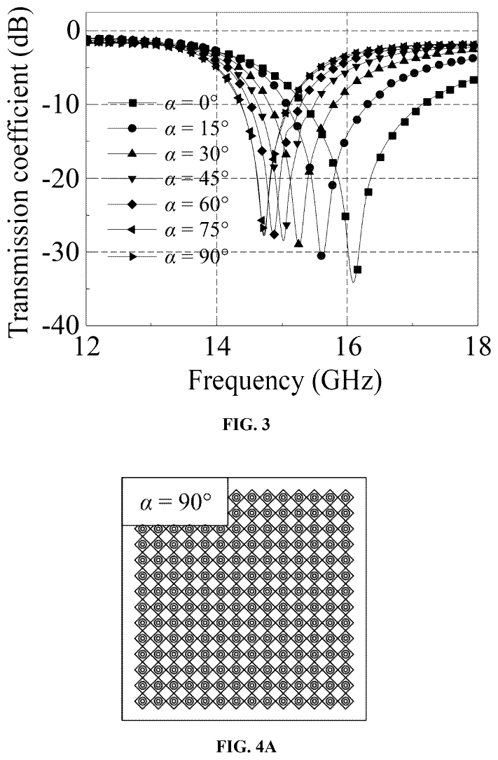

To verify that the MRFSS structure has the capability of mechanical tuning, full-wave electromagnetic simulation is performed on the MRFSS structures shown in FIGS. 1A-1D by using CST Studio Suite software, where a transmission coefficient of an infinite RFSS structure is simulated by using a Floquet port and a periodic boundary condition. The included angle between adjacent squares is controlled to be gradually reduced from 90° to 0°, simulation is performed every 15°. The full-wave electromagnetic simulation results of the MRFSS structures with different included angles between adjacent squares when the electromagnetic waves enter perpendicularly are shown in FIG. 3. As can be seen from FIG. 3, the proposed RFSS has a fist-order band-stop frequency response. By rotating the squares, continuous frequency tuning of a resonant point of the stopband from 14.73 GHz to 16.1 GHz is achieved, with a tuning range of 1.37 GHz. The −10 dB bandwidth ranges from 0.732 GHz to 1.826 GHz, which gradually increases as the angle α decreases.

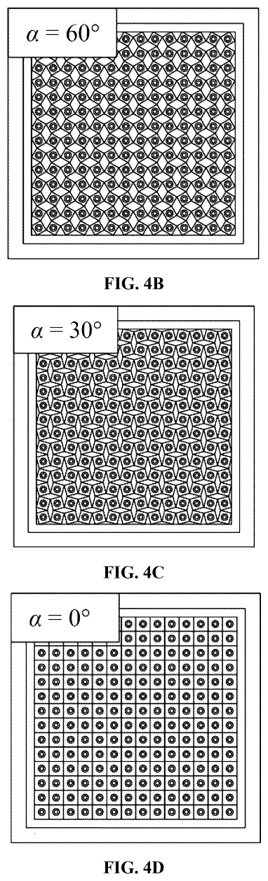

To further verify the effectiveness of the MRFSS structure, a MRFSS sample is manufactured. FIG. 4A is a diagram of the overall structure of the MRFSS sample with a 90° included angle α between adjacent squares, FIG. 4B is a diagram of the overall structure of the MRFSS sample with a 60° included angle α between adjacent squares, FIG. 4C is a diagram of the overall structure of the MRFSS sample with a 30° included angle α between adjacent squares, and FIG. 4D is a diagram of the overall structure of the MRFSS sample with a 0° included angle α between adjacent squares. The overall dimension of the sample is 194.2 mm*194.2 mm, and the sample includes 14*14 units.

At first, the dielectric substrate 1 in the rotating rigid structure is fabricated via a 3D printing technology, the dielectric substrate 1 in the rotating rigid structure is made of a 3D-printed flexible filament material with a dielectric constant εr of 2.7 and a loss tangent tan δ of 0.008.

Then, an annular conductive layer is printed on the dielectric substrate 1 in the rotating rigid structure via a conductive ink printing technology, and the annular conductive layer is made of silver paste conductive ink.

It should be noted that for the convenience of simulation, the MRFSS shown in FIGS. 1A-1D is an ideal unit structure, and a thickness of the connection between the squares in the rotating rigid structure is 0. In the sample fabrication, the thickness of the connection between the squares of the rotating rigid structure is set to 0.4 mm. Through simulation analysis, the slight change in the thickness of the connection between the squares has a negligible effect on the transmission coefficient of the MRFSS.

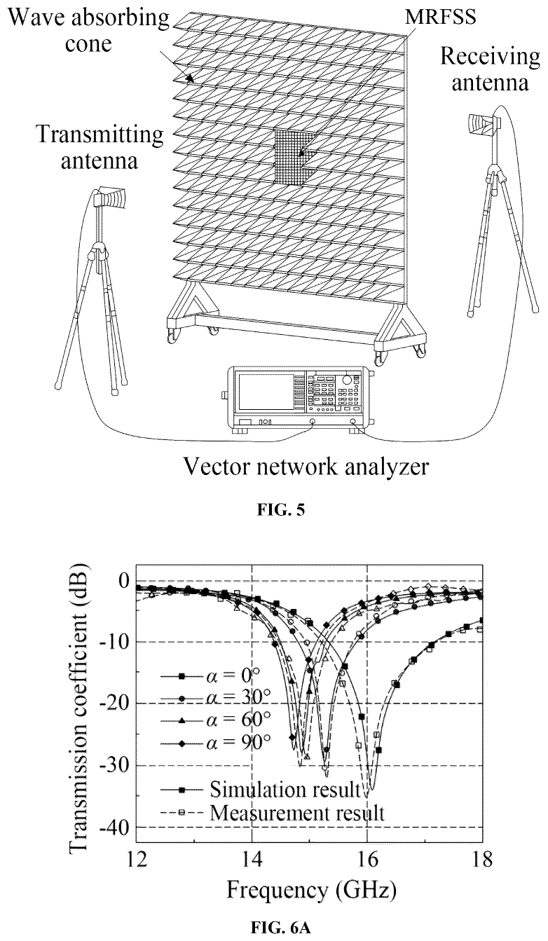

A free space measurement method is employed in a microwave darkroom to measure a transmission coefficient of the MRFSS sample. As shown in FIG. 5, a used instrument includes a vector network analyzer (Agilent N5242A), and transmitting and receiving antennas (ETS-LINDGREN3117). To ensure a far-field condition, the antenna is about 2 m away from the sample. To reduce an edge effect and improve testing accuracy, the sample is placed at the middle of a tapered wave absorber. A transmission coefficient measured by the tapered wave absorber without placing the sample is used as a normalization coefficient, and a time domain gating technology is adopted to filter out the influence of diffracted waves on a measurement result.

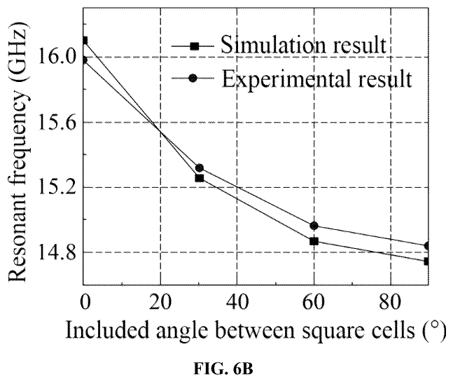

The transmission coefficient result of the sample subjected to the perpendicularly incident electromagnetic waves is shown in FIGS. 6A and 6B. FIG. 6A is measured transmission coefficients of the MRFSS sample with different included angles between adjacent squares, and FIG. 6B is a comparison diagram of measured resonant frequencies and simulated resonant frequencies. As the included angle between the adjacent squares decreases from 90° to 0°, the resonant frequency of the MRFSS decreases from 15.98 GHz to 14.84 GHz, and a measurement result has better consistency with the simulation result. Some slight insertion loss deviations and low-frequency fluctuations are caused by a fabrication error, slightly higher resistivity of the conductive ink, a material dielectric offset, and a limited size of the sample. It is noted that a tuning range measured by the experiment is slightly smaller than that of the simulation result, the reason is that, when α is 0°, tiny air gaps between the squares of the substrates of the MRFSS causes a smaller tuning range.

Finally, it should be noted that the foregoing embodiments are merely used to describe the technical solution of the present disclosure, rather than limitation. Although the present disclosure is described in detail with reference to the foregoing embodiments, a person of ordinary skill in the art should understand that: the technical solutions described in the foregoing embodiments may still be modified, or some technical features thereof may be equivalently replaced. These modifications or replacements shall not cause the essential nature of the corresponding technical solution to deviate from the spirit and scope of the technical solutions in the embodiments of the present disclosure, and shall be encompassed within the scope of protection of the present disclosure.

### DOCUMENT LIST

[1] M. Tang, D. F. Zhou, Q. K. Liu, Z. N. Yao, and Q. Liu, “Low-Profile FSS-Based Polarization Insensitive Rasorber With Switchable Transmission Band”, Antennas Wirel. Propag. Lett., vol. 20, no. 6, pp 10381042, June 2021, doi: 10.1109/LAWP. 2021. 3070148.
[2] S. Ghosh and K. V. Srivastava, “A Dual-Band Tunable Frequency Selective Surface With Independent Wideband Tuning”, Antennas Wirel. Propag. Lett., vol. 19, no. 10, pp. 1808-1812, October 2020, doi: 10.1109/LAWP. 2020. 3019584.
[3] H. Bai et al., “Tunable Frequency Selective Surface With Angular Stability”, Antennas Wirel. Propag. Lett., vol. 20, no. 6, pp. 1108-1112, June 2021, doi: 10.1109/LAWP.2021.3073907.
[4] W. Hu et al., “Liquid Crystal Tunable mm Wave Frequency Selective Surface,” IEEE Microw. Wireless Compon. Lett., vol. 17, no. 9, pp. 667-669, September 2007, doi: 10.1109/LMWC. 2007. 903455.
[5] Y. Zhang, J. H. Wang, T. Dong, and J. Yin, “A frequency and polarization reconfigurable frequency selective surface based on liquid crystal”, in 2018 International Workshop on Antenna Technology (iWAT), Nanjing: IEEE, March 2018, pp. 1-4. doi: 10.1109/IWAT. 2018. 8379230.
[6] J. F. Lv et al., “Tunable liquid crystal frequency selective surface with the compact unit cell, large tuning range, and the passband of flat-top and sharp roll-off”, J. Phys. D: Appl. Phys., vol. 54, no. 31, p. 315001, August 2021, doi: 10.1088/1361-6463/ac000c.
[7] Saidatul. Norlyana. Azemi, Kamran. Ghorbani, and Wayne. S. T. Rowe, “A Reconfigurable FSS Using a Spring Resonator Element”, Antennas Wirel. Propag. Lett., vol. 12, pp. 781-784, 2013, doi: 10.1109/LAWP. 2013. 2270950.
[8] S. M. Amin Momeni Hasan Abadi, J. H. Booske, and N. Behdad, “Exploiting Mechanical Flexure as a Means of Tuning the Responses of Large-Scale Periodic Structures”, IEEE Trans. Antennas Propagat., vol. 64, no. 3, pp. 933-943, March 2016, doi: 10.1109/TAP. 2015. 2513418.
[9] R. Sivasamy, B. Moorthy, M. Kanagasabai, V. R. Samsingh, and M. G. N. Alsath, “A Wideband Frequency Tunable FSS for Electromagnetic Shielding Applications”, IEEE Trans. Electromagn. Compat., vol. 60, no. 1, pp. 280-283, February 2018, doi: 10.1109/TEMC.2017.2702572.
[10] S. Qiu, Q. Guo, and Z. Li, “Tunable Frequency Selective Surface Based on a Sliding 3D-Printed Inserted Dielectric”, IEEE Access, vol. 9, pp. 19743-19748, 2021, doi: 10.1109/ACCESS. 2021. 3054434.
[11] K. Fuchi, Junyan Tang, B. Crowgey, A. R. Diaz, E. J. Rothwell, and R. O. Ouedraogo, “Origami Tunable Frequency Selective Surfaces”, Antennas Wirel. Propag. Lett., vol. 11, pp. 473-475, 2012, doi: 10.1109/LAWP. 2012. 2196489.
[12] S. A. Nauroze, L. Novelino, M. M. Tentzeris, and G. H. Paulino, “Inkjet-printed ‘4D’ tunable spatial filters using on-demand foldable surfaces”, in 2017 IEEE MTT-S International Microwave Symposium (IMS), Honololu, HI, USA: IEEE, June 2017, pp. 1575-1578. doi: 10.1109/MWSYM. 2017. 8058932.
[13] K. Fuchi et al., “Design Optimization of Origami-Tunable Frequency Selective Surfaces”, IEEE Open J. Antennas Propag., vol. 2, pp. 897-910, 2021, doi: 10.1109/OJAP. 2021. 3107434.
[14] S. A. Nauroze and M. M. Tentzeris, “A Thermally Actuated Fully Inkjet-Printed Origami-Inspired Multilayer Frequency Selective Surface With Continuous-Range Tunability Using Polyester-Based Substrates”, IEEE Trans. Microwave Theory Techn., vol. 67, no. 12, pp. 4944-4954, December 2019, doi: 10.1109/TMTT. 2019. 2946074.
[15] X. Fan et al., “Design and fabrication of a reconfigurable and flexible frequency selective surface with a buckling dipole via mechanical stretching”, SS, 2021, doi: 10.20517/ss. 2021. 18.
[16] Y. Zhu et al., “Flexible Double-Layer Adjustable Frequency Selective Surfaces Based on 3D Cross-Shaped Kirigami Structure”, Adv Materials Technologies, vol. 9, no. 5, p. 2301715, March 2024, doi: 10.1002/admt. 202301715.
[17] X. Fan, Y. Li, S. Chen, Y. Xing, and T. Pan, “Mechanical Terahertz Modulation by Skin-Like Ultrathin Stretchable Metasurface”, Small, vol. 16, no. 37, p. 2002484, September 2020, doi: 10.1002/smll. 202002484.
[18] Y. Yang, A. Vallecchi, E. Shamonina, C. J. Stevens, and Z. You, “A new class of transformable kirigami metamaterials for reconfigurable electromagnetic systems”, Sci Rep, vol. 13, no. 1, p. 1219, January 2023, doi: 10.1038/s41598-022-27291-8.

What is claimed is:

1. A tunable mechanically reconfigurable frequency selective surface based on rotating rigid structures, comprising N frequency selective surface units,
wherein the N frequency selective surface units are in an arrangement of a periodic shape array;
each of the N frequency selective surface units comprises four frequency selective surface subunits;
each of the four frequency selective surface subunits comprises a dielectric substrate and an annular conductive layer;
the annular conductive layer is arranged on a surface of the dielectric substrate; and
the four frequency selective surface subunits are connected in such a way that angles between adjacent frequency selective surface subunits are α degrees, 180-α degrees, α degrees and 180-α degrees.

2. The tunable mechanically reconfigurable frequency selective surface based on rotating rigid structures according to claim 1, wherein the arrangement of the periodic shape array comprises a matrix arrangement.

3. The tunable mechanically reconfigurable frequency selective surface based on rotating rigid structures according to claim 1, wherein the dielectric substrate is in a rotating rigid structure.

4. The tunable mechanically reconfigurable frequency selective surface based on rotating rigid structures according to claim 1, wherein the dielectric substrate is square.

5. The tunable mechanically reconfigurable frequency selective surface based on rotating rigid structures according to claim 1, wherein a center of the annular conductive layer coincides with a center of the dielectric substrate.

6. The tunable mechanically reconfigurable frequency selective surface based on rotating rigid structures according to claim 1, wherein 0°≤α≤90°.

7. The tunable mechanically reconfigurable frequency selective surface based on rotating rigid structures according to claim 1, wherein a distance d1 from an outer edge of the annular conductive layer to an edge of the dielectric substrate is greater than 0.

8. The tunable mechanically reconfigurable frequency selective surface based on rotating rigid structures according to claim 1, wherein a distance d2 between centers of annular conductive layers of adjacent frequency selective surface subunits is greater than 0.

9. The tunable mechanically reconfigurable frequency selective surface based on rotating rigid structures according to claim 1, wherein the adjacent frequency selective surface subunits are connected by a hinge structure.

10. The tunable mechanically reconfigurable frequency selective surface based on rotating rigid structures according to claim 1, wherein the annular conductive layer is made of a high-conductivity material.
